(19) United States
(12) Patent Application Publication
(10) Pub. No.: US 2009/0248673 A1
(43) Pub. Date: Oct. 1, 2009

(54) METHOD OF SORTING WEB PAGES, SEARCH TERMINAL AND CLIENT TERMINAL

(75) Inventors: LUNG DAI, Tu-Cheng (TW); WANG-CHANG DUAN, Shenzhen City (CN); BANG-SHENG ZUO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY CO., LTD., Shenzhen City, Guangdong Province (CN); HON HAI PRECISION INDUSTRY CO., LTD., Tu-Cheng (TW)

(21) Appl. No.: 12/350,168

(22) Filed: Jan. 7, 2009

(30) Foreign Application Priority Data
Mar. 27, 2008 (CN) 200810300743.5

(51) Int. Cl. G06F 17/30

(52) U.S. Cl. 707/5; 707/7; 707/E17.014; 707/E17.109

(57) ABSTRACT

A method of sorting web pages includes the steps of acquiring a plurality of forbidden keywords, receiving information of a list of web pages provided by a search engine, separating the web pages into valid web pages and invalid web pages according to forbidden keywords, rearranging the information of the valid web pages and the invalid web pages, and outputting the rearranged information of the valid web pages and the invalid web pages. A related search terminal and a client terminal are also provided.

### BACKGROUND

1. Technical Field

The present disclosure relates to methods of sorting web pages, and more particularly to a method of sorting web pages, and a search terminal and a client terminal implementing the method.

2. Description of Related Art

Search engines, such as Baidu®, Google , Yahoo®, etc., are generally used for searching web sites according to one or more keywords inputted by users. The information returned from these web sites may includes titles, links, universal resource locators (URLs) and short quotes of relevant sections of web pages on the web sites.

In order to ensure information security, some companies set their servers to block access to certain outside web pages. The server may also be preset to identify and block web pages that contains keywords, such as bbs, blog, forum, etc. Accordingly, the server can block access to a web page if information of the web page contains one of the forbidden keywords. The web pages not blocked by the server are defined as valid web pages, and the web pages blocked by the server are defined as invalid web pages.

However, the information of the web pages provided by the search engines may include links to the valid web pages as well as those to the invalid web pages. Therefore, users inevitably spend a lot of unnecessary time attempting to access the invalid web pages.

Therefore, a need exists for a method of sorting web pages, and a search terminal and a client terminal implementing the method to resolve the above problem.

### BRIEF DESCRIPTION OF THE DRAWINGS

FIG. 1 is a flow chart illustrating a method of sorting web pages in accordance with an exemplary embodiment of the disclosure.

FIG. 2 is a block diagram of a system implementing the method of FIG. 1 according to a first embodiment of the disclosure.

FIG. 3 is a block diagram of a system implementing the method of FIG. 1 according to a second embodiment of the disclosure.

### DETAILED DESCRIPTION

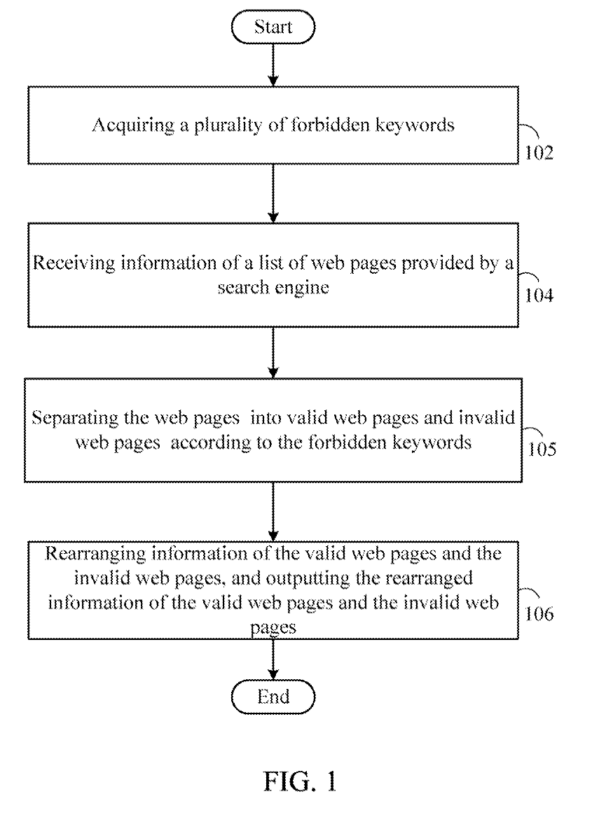

Referring to FIG. 1, a method of sorting web pages is illustrated in accordance with an exemplary embodiment of the disclosure. In step 102, acquiring a plurality of forbidden keywords. In this embodiment, the forbidden keywords are preset in a server.

In step 104, receiving information of a list of web pages provided by a search engine. The information of the web pages includes titles, links, URLs, and short quotes of relevant sections of the web pages.

In step 105, separating the web pages into valid web pages and invalid web pages according to the forbidden keywords. In the embodiment, the separating step includes: searching information of each of the web pages, designating one or more of the web pages which do not contain any of the forbidden keywords as valid web pages; and designating the remaining web pages, as invalid web pages.

In step 106, rearranging the information of the valid web pages and the invalid web pages, and outputting the rearranged information of the valid web pages and the invalid web pages. Herein, three embodiments of rearranging the information of the valid web pages and the invalid web pages will be illustrated. In the first embodiment, the information of the invalid web pages is deleted, thus the information of the valid web pages is outputted.

In the second embodiment, the information of the valid web pages and the invalid web pages are rearranged and outputted in different columns. For example, the information of the valid web pages is displayed in one column on the left of a screen, and the information of the invalid web pages is displayed in another column on the right of the screen, or vice versa.

In the third embodiment, all the information of the valid web pages are rearranged and outputted before the information of the invalid web pages. For example, all the information may be displayed in a single column with the information of the valid web pages appearing before that of the invalid web pages.

The method of sorting web pages prevents users from wasting time clicking on links to the invalid web pages provided by the search engine.

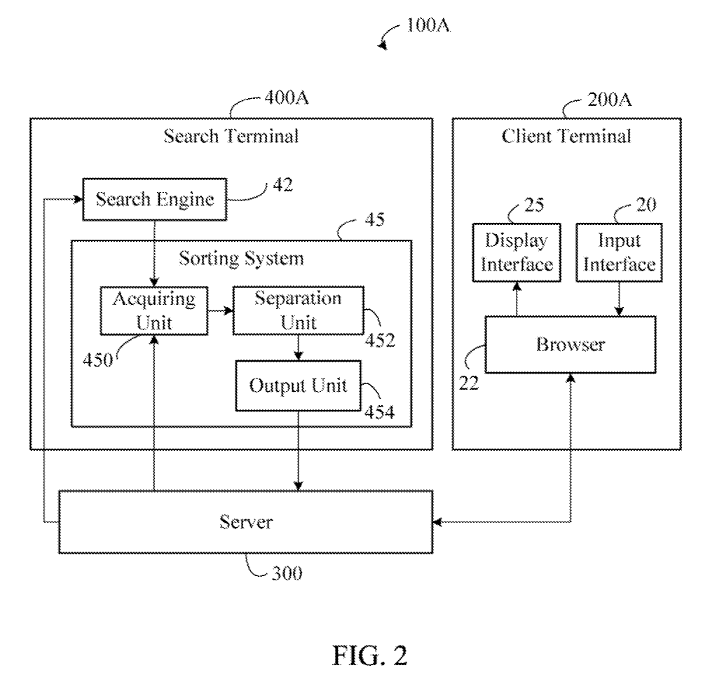

Referring to FIG. 2, a system 100A implementing the method of FIG. 1 is illustrated according to a first embodiment of the disclosure. The system 100A includes a client terminal 200A, a server 300, and a search terminal 400A. The server 300 exchanges data with the search terminal 400A through a network (not shown), such as the Internet or a local area network (LAN). The client terminal 200A also exchanges data with the search terminal 400A through the server 300. The search terminal 400A includes a search engine 42 and a sorting system 45 connected between the search engine 42 and the server 300.

The client terminal 200A includes an input interface 20, a browser 22, and a display interface 25. The input interface 20 is used for providing a URL of the search engine 42 and inputting search terms, such as search keywords, to the browser 22. The browser 22 links to a web page of the search engine 42 according to the URL, and sends the search terms to the search engine 42 through the server 300.

The server 300 has preset a plurality of forbidden keywords, receives information of web pages provided by the search engine 42 in response to a search, and detects whether the information of each of the web pages contain one or more of the forbidden keywords. The server 300 blocks the browser 22 from accessing to any web page having information containing one or more forbidden keywords, but allows the browser 22 to access the remaining web pages.

The search engine 42 is used for returning a list of web pages, including the information of each web pages, in response to search terms inputted by a user.

The sorting system 45 includes an acquiring unit 450, a separation unit 452, and an output unit 454. The acquiring unit 450 is used for receiving the information of the web pages from the search engine 42, and acquiring forbidden keywords from the server 300.

The separation unit 452 is used for separating the web pages into valid web pages and invalid web pages according to forbidden keywords, by searching through the information of each of the web pages, so that access to the invalid web pages may be blocked by the server 300.

The output unit 454 extracts information of the valid web pages from information of all the web pages, and outputs the extracted information of the valid web pages. Herein, three embodiments of extracting information of the valid web pages from information of all the web pages will be illustrated. In the first embodiment, the output unit 454 deletes the information of the invalid web pages, and outputs the remaining information.

In the second embodiment, the output unit 454 rearranges and outputs the information of the valid web pages and the invalid web pages in different columns. For example, the information of the valid web pages is displayed in a column on the left of a screen, and the information of the invalid web pages is displayed in another column on the right of the screen, or vice versa.

In the third embodiment, the output unit 454 rearranges and outputs all the information of the valid web pages before the information of the invalid web pages. Accordingly, the browser 22 receives the information from the output unit 454 through the server 300, and the display interface 25 can display the information. Therefore, the system 100A of sorting web pages can prevent users from wasting time clicking on links to the invalid web pages.

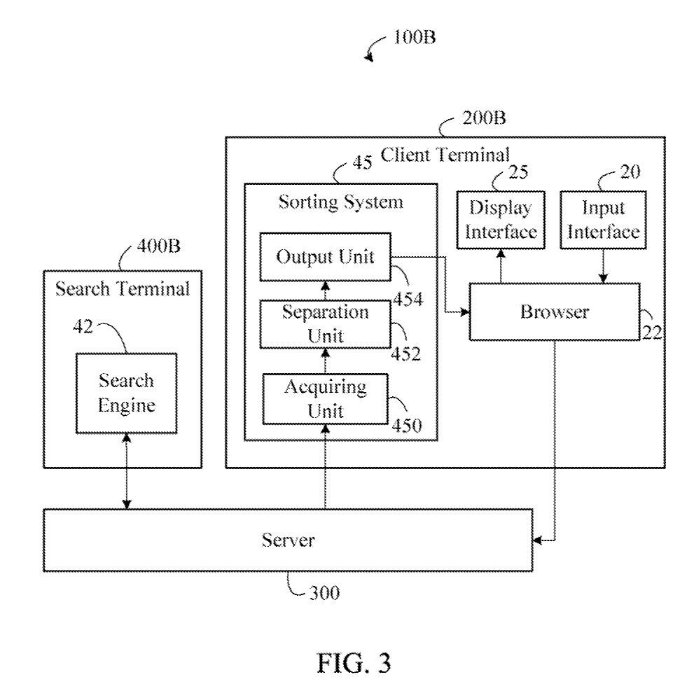

Referring to FIG. 3, a system 100B of sorting web pages implements the method of FIG. 1 according to the second embodiment of the disclosure is illustrated. The system 100B includes a client terminal 200B, the server 300, and a search terminal 400B. The system 100B is similar with the system 100A, except the sorting system 45 is formed in the client terminal 200B and not in the search terminal 400B. The sorting system 45 is connected between the server 300 and the browser 22.

Alternative embodiments will become apparent to those skilled in the art to which the present invention pertains without departing from the spirit and scope. Accordingly, the present invention should be deemed not to be limited to the above detailed description, but rather by the claims that follow.

What is claimed is:

1. A method of sorting web pages comprising:
acquiring a plurality of forbidden keywords;
receiving information of a list of web pages provided by a search engine;
separating the web pages into valid web pages and invalid web pages according to forbidden keywords; and
rearranging the information of the valid web pages and the invalid web pages, and outputting the rearranged information of the valid web pages and the invalid web pages.

2. The method as claimed in claim 1, wherein the separating step comprises steps of:
searching information of each of the web pages;
determining one of the web pages is the valid web page on condition that the information of the one of the web pages does not contain any of the forbidden keywords; and
determining one of the web pages is the invalid web page on condition that the information of the one of the web pages contains one or more of the forbidden keywords.

3. The method as claimed in claim 1, wherein the step of rearranging the information of the valid web pages and the invalid web pages is: deleting the information of the invalid web pages, and outputting the information of the valid web pages.

4. The method as claimed in claim 1, wherein the step of rearranging the information of the valid web pages and the invalid web pages is: rearranging and outputting the information of the valid web pages and invalid web pages in different columns.

5. The method as claimed in claim 1, wherein the step of rearranging the information of the valid web pages and the invalid web pages is: rearranging and outputting all the information of the valid web pages before the information of the invalid web pages.

6. A search terminal comprising:
a search engine configured for providing information of a list of web pages; and
a sorting system configured for being connected between the search engine and a server, the sorting system comprising:
an acquiring unit configured for acquiring forbidden keywords preset in the server;
a separating unit configured for separating the web pages into valid web pages and invalid web pages according to the forbidden keywords; and
an output unit configured for extracting information of the valid web pages from information of all the web pages, and outputting the extracted information of the valid web pages.

7. The search terminal as claimed in claim 6, wherein the server allows the browser to access the valid web pages, and the server prevents the browser from accessing the invalid web pages.

8. The search terminal as claimed in claim 6, wherein the separation unit is configured for searching information of each of the web pages, designating one or more of the web pages, containing one or more of the forbidden keywords, as the invalid web pages; and designating the remaining web pages, as the valid web pages.

9. The search terminal as claimed in claim 6, wherein the output unit is configured for deleting the information of the invalid web pages, and outputting the information of the valid web pages.

10. The search terminal as claimed in claim 6, the output unit is configured for rearranging and outputting the information of the valid web pages and the invalid web pages in different columns.

11. The search terminal as claimed in claim 6, wherein the output unit is configured for rearranging and outputting all the information of the valid web pages before the information of the invalid web pages.

12. A client terminal comprising:
a browser configured for sending search keywords to a search engine; and
a sorting system configured for receiving information of a list of web pages acquired by the search engine according to the search keywords through a server, the sorting system comprising:
an acquiring unit configured for acquiring forbidden keywords preset in the server;
a separating unit configured for separating the web pages into valid web pages and invalid web pages according to forbidden keywords; and
an output unit configured for extracting information of the valid web pages from information of all the web pages, and outputting the extracted information of the valid web pages.

13. The client terminal as claimed in claim 12, wherein the server allows the browser to access the valid web pages, and the server prevents the browser from accessing the invalid web pages.

14. The client terminal as claimed in claim 12, further comprising a display interface for displaying the extracted information of the valid web pages.

15. The client terminal as claimed in claim 12, wherein the separation unit is configured for searching information of each of the web pages, designating one or more of the web pages, containing one or more of the forbidden keywords, as the invalid web pages; and designating the remaining web pages, as the valid web pages.

16. The client terminal as claimed in claim 12, wherein the output unit is configured for deleting the information of the invalid web pages, and outputting the information of the valid web pages.

17. The client terminal as claimed in claim 12, wherein the output unit is configured for rearranging and outputting the information of the valid web pages and the invalid web pages in different columns.

18. The client terminal as claimed in claim 17, wherein the information of the valid web pages is displayed in one column on the left of the screen, and the information of the invalid web pages is displayed in another column on the right of the screen.

19. The client terminal as claimed in claim 12, wherein the output unit is configured for rearranging and outputting all the information of the valid web pages before the information of the invalid web pages.
